(19) United States
(12) Patent Application Publication
(10) Pub. No.: US 2026/0115071 A1
(43) Pub. Date: Apr. 30, 2026

(54) PRACTICAL AND ECONOMICAL MEDICAL NURSING BED

(71) Applicant: ANHUI LANGWEI MEDICAL DEVICE TECHNOLOGY CO., LTD., MINGGUANG CITY (CN)

(72) Inventors: XIAOSHENG XIE, MINGGUANG CITY (CN); CAIHONG WEI, MINGGUANG CITY (CN)

(21) Appl. No.: 19/030,450

(22) Filed: Jan. 17, 2025

(30) Foreign Application Priority Data
Oct. 31, 2024 (CN) 202422646708.6

(51) Int. Cl. A61G 7/05

(52) U.S. Cl. CPC A61G 7/0509; A61G 7/0506

(57) ABSTRACT

Disclosed is a practical and economical medical nursing bed, which includes two head bed frame assemblies and guardrail assemblies. The guardrail assemblies are movably mounted on sides of the head bed frame assemblies. With this arrangement, the guardrail assemblies are conveniently mounted on sides of the head bed frame assemblies and can be removed for use at any time. Each guardrail assembly includes a guardrail body and a guardrail slot, the medical nursing bed includes a bed head hanger piece, a connecting rod, a back bed frame assembly and a leg bed frame assembly, the guardrail body is movably mounted on one side of each head bed frame assembly, the guardrail slot is formed in one side of each head bed frame assembly, and the guardrail body is detachably mounted on an inner side of the guardrail slot.

### CROSS REFERENCE TO RELATED APPLICATION

This application claims the priority of Chinese Patent Application No. 202422646708.6, entitled “PRACTICAL AND ECONOMICAL MEDICAL NURSING BED”, filed with the Chinese Patent National Intellectual Property Administration on Oct. 31, 2024, which is incorporated herein by reference in its entirety as part of the present application.

### TECHNICAL FIELD

The disclosure relates to the technical field of medical and nursing care, and in particular to a practical and economical medical nursing bed.

### BACKGROUND

Medical nursing beds greatly improve the level of rehabilitation care of patients and also provide great convenience for caregivers, and therefore the medical nursing beds have been increasingly sought after in the market; guardrails are a very important part of the medical nursing beds and have a high usage frequently, and therefore the safety of the guardrails is the focus of attention of consumers.

In the document of the prior art with Chinese patent CN219332256U, a conventional electric medical bed has multiple problems, such as inconvenient mounting of guardrails, an increase in the size of a bed body due to a bed head hanger piece arranged on an outer side of the bed body, and a high cost due to multiple motors required for lifting the bed body. Therefore, the disclosure provides a practical and economical medical nursing bed in order to solve the problems existing in the prior art.

### SUMMARY

In view of the above-mentioned problems, an object of the disclosure is to provide a practical and economical medical nursing bed. The practical and economical medical nursing bed uses detachable guardrails which can be removed only by pulling handles on the guardrails on two sides, and can achieve raising and lowering functions of a bed body by means of a rotating motor and a connecting rod; a bed frame structure is redesigned by mounting a bed head hanger piece to a bed frame, and holes are formed inside head bed frames to fix pins, such that the size of the bed body is reduced.

To achieve the object of the disclosure, the disclosure is implemented by the following technical solution. A practical and economical medical nursing bed includes two head bed frame assemblies and guardrail assemblies, wherein the guardrail assemblies are movably mounted on sides of the two head bed frame assemblies respectively, and with this arrangement, the guardrail assemblies are conveniently mounted on sides of the head bed frame assemblies and can be removed for use at any time. Each guardrail assembly includes a guardrail body and a guardrail slot. The medical nursing bed includes a bed head hanger piece, a connecting rod, a back bed frame assembly and a leg bed frame assembly; the guardrail body is movably mounted on the side of each head bed frame assembly, the guardrail slot is formed in the side of each head bed frame assembly, the bed head hanger piece is fixedly mounted on an inner side of one of the two head bed frame assemblies, the connecting rod is movably mounted between the two head bed frame assemblies, the back bed frame assembly is fixedly mounted on one side of the two head bed frame assemblies, the back bed frame assembly is arranged at a bottom of the medical nursing bed, and the leg bed frame assembly is movably mounted between the two head bed frame assemblies.

In some embodiments, a rotating motor is fixedly mounted on one side of the back bed frame assembly, a foot bed frame assembly is fixedly mounted on opposite sides of the head bed frame assemblies, and the foot bed frame assembly is arranged at a foot portion of the medical nursing bed.

In some embodiments, a spring is movably mounted inside the guardrail slot.

In some embodiments, a gear seat is fixedly mounted on one side of the rotating motor, and the gear seat is arranged on one side of the foot bed frame assembly.

In some embodiments, a handle is movably mounted on one side of one head bed frame assembly, and the handle is arranged on one side of the guardrail slot.

In some embodiments, mounting holes are formed in one side of the head bed frame assemblies, and fixing pins are arranged inside the mounting holes.

In some embodiments, multiple back bed frame assemblies are provided, and each back bed frame assembly has the same specification and function.

The disclosure has the beneficial effects: the disclosure is used by means of the cooperation of the head bed frame assemblies, guardrails, the guardrail slots, the bed head hanger piece, the connecting rod, the back bed frame assembly, the leg bed frame assembly, the rotating motor, the foot bed frame assembly, the springs, the gear seat and the handles, uses the detachable guardrails which can be removed only by pulling the handles on the guardrails on two sides, and can achieve raising and lowering functions of the bed body by means of a rotating motor and the connecting rod; a bed frame structure is redesigned by mounting the bed head hanger piece to a bed frame, and holes are formed inside head bed frames to fix pins, such that the size of the bed body is reduced. The heights of the guardrails are adjusted by the drive of the rotating motor, so as to achieve multiple height adjustments, meeting the demands of different patients; in addition, the guardrails are arranged to play a protective effect, and are electrically raised and lowered to save manpower.

### BRIEF DESCRIPTION OF THE DRAWINGS

To illustrate the technical solutions in the embodiments of the disclosure or the prior art more clearly, the accompanying drawings required for the embodiments will be briefly described below. Apparently, the accompanying drawings in the following description show merely some embodiments of the disclosure, and those of ordinary skill in the art may still derive other accompanying drawings from these accompanying drawings without creative efforts.

FIG. 1 is a cross-sectional view of a product of the disclosure;

FIG. 2 is an axial view of the product of the disclosure.

In the figures: 1. head bed frame assembly; 2. guardrail body; 3. guardrail slot; 4. bed head hanger piece; 5. connecting rod; 6. back bed frame assembly; 7. leg bed frame assembly; 8. rotating motor; 9. foot bed frame assembly; 10. spring; 11. gear seat; 12. handle.

### DETAILED DESCRIPTION OF THE EMBODIMENTS

The technical solutions of embodiments will be clearly and completely described below with reference to the accompanying drawings in the embodiments of the disclosure. Apparently, the embodiments described are merely some rather than all of the embodiments of the present disclosure. On the basis of the embodiments of the disclosure, all other embodiments obtained by a person of ordinary skill in the art on the premise of no creative work shall fall within the scope of protection of the disclosure.

In this description of the disclosure, it should be noted that unless otherwise explicitly specified and defined, the terms “mounting”, “connecting” and “attaching” should be understood in a broad sense, for example, they may be a fixed connection, a detachable connection, or an integrated connection, may be a mechanical connection or an electrical connection, may be a direct connection, an indirect connection by means of an intermediary, or may be an internal communication between two elements. For those of ordinary skill in the art, the specific meanings of the terms mentioned above in the disclosure should be construed according to specific circumstances.

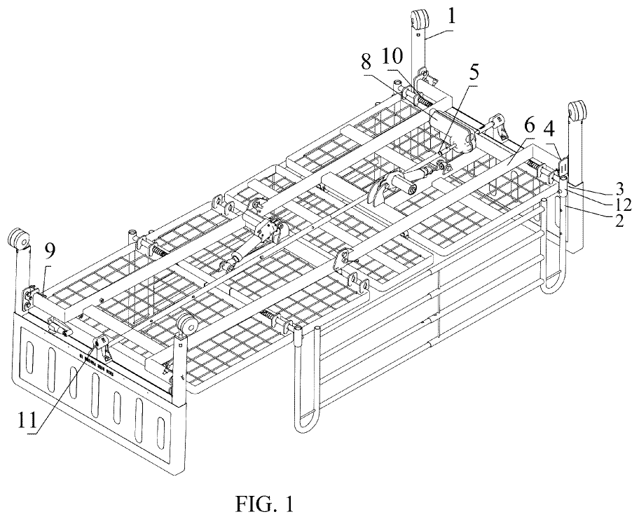

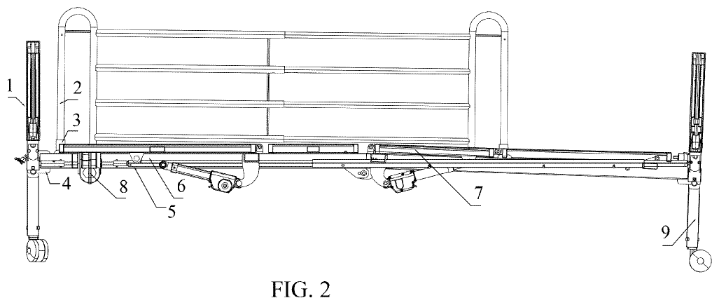

According to FIGS. 1 and 2, this embodiment provides a practical and economical medical nursing bed, which includes two head bed frame assemblies 1 and guardrail assemblies. The guardrail assemblies are movably mounted on sides of the two head bed frame assemblies 1 respectively, and with this arrangement, the guardrail assemblies are conveniently mounted on sides of the head bed frame assemblies 1 and can be removed for use at any time. Each guardrail assembly includes a guardrail body 2 and a guardrail slot 3. The medical nursing bed includes a bed head hanger piece 4, a connecting rod 5, a back bed frame assembly 6 and a leg bed frame assembly 7. The guardrail body 2 is movably mounted on the side of each head bed frame assembly 1, the guardrail slot 3 is formed in the side of each head bed frame assembly 1, the guardrail body 2 is detachably mounted on an inner side of the guardrail slot 3, the bed head hanger piece 4 is fixedly mounted on an inner side of one of the head bed frame assemblies 1, and the connecting rod 5 is movably mounted between two head bed frame assemblies 1; the back bed frame assembly 6 is fixedly mounted on one side of one of the head bed frame assemblies 1, the back bed frame assembly 6 is arranged at the bottom of the medical nursing bed, and the leg bed frame assembly 7 is movably mounted between the two head bed frame assemblies 1. The guardrails are mounted on outer sides of the medical nursing bed by arranging the guardrail bodies 2, and the guardrail bodies 2 are inserted and mounted for use by arranging the guardrail slots 3. Dietary preferences, medications and other special nursing requirements of the patient are recorded by the bed head hanger piece 4, and accordingly it is ensured that the patient obtains a customized medical service. The bottom of the medical nursing bed is supported for use by the back bed frame assembly 6, and it is convenient to support and fix legs on the medical nursing bed by arranging the leg bed frame assembly 7.

A rotating motor 8 is fixedly mounted on one side of the back bed frame assembly 6, a foot bed frame assembly 9 is fixedly mounted on opposite sides of the head bed frame assemblies 1, the foot bed frame assembly 9 is arranged at a foot portion of the medical nursing bed, and the rotating motor 8 is configured to drive raising and lowering functions of a bed body.

A spring 10 is movably mounted inside each guardrail slot 3, the spring 10 is configured to turn the guardrail slot 3 by an angle, and the internal spring 10 is also retractable to withdraw the guardrail slot 3, such that repeated mounting and removal are not required.

A gear seat 11 is fixedly mounted on one side of the rotating motor 8, and the gear seat 11 is arranged on one side of the foot bed frame assembly 9. By arranging the gear seat 11, the motor drives the gear seat 11 to rotate during the rotation, achieving the raising and lowering functions of the bed body.

A handle 12 is movably mounted on one side of each head bed frame assembly 1, and the handle 12 is arranged on one side of the guardrail slot 3. By arranging the handle 12, the guardrail can be removed only by pulling the handle 12 in the guardrail slot 3.

Mounting holes are formed in one side of the head bed frame assembly 1, and fixing pins are arranged on one side of the mounting holes. It is convenient to mount a head bed frame for use by means of the mounting holes and the fixing pins.

Multiple back bed frame assemblies 6 are provided, each back bed frame assembly 6 has the same specification and function, and the bottom of the medical nursing bed is stabilized for use by means of the cooperation of the back bed frame assemblies 6 and other assemblies.

When this practical and economical medical nursing bed is used, the removable guardrails are used and can be removed only by pulling the handles 12 in the guardrail slots 3, and by turning the guardrail slots 3 by an angle, and the guardrail slots can also be withdrawn by the retractable internal spring 10, such that repeated mounting and removal are not needed; the gear seat 11 on the foot bed frame is connected to the rotating motor 8 via the connecting rod, such that the motor drives the gear seat 11 to rotate during the rotation, achieving the raising and lowering functions of the bed body. Structures of the back bed frame assemblies 6 and the leg bed frame assembly 7 are redesigned by mounting the bed head hanger piece 4 to a bed frame, so that the width of the bed frame is less than the width of a bed surface, and the size of the bed body is also reduced while hand pinching is prevented. With this arrangement, the guardrail assemblies are conveniently mounted on sides of the head bed frame assemblies 1 and can be removed for use at any time, the guardrails are mounted on the outer sides of the medical nursing bed by arranging the guardrail bodies 2, the guardrail bodies 2 are inserted and mounted for use by arranging the guardrail slots 3. The dietary preferences, the medications and other special nursing requirements of the patient are recorded by the bed head hanger piece 4, and accordingly it is ensured that the patient obtains a customized medical service. The bottom of the medical nursing bed is supported for use by the back bed frame assemblies 6, and it is convenient to support and fix legs on the medical nursing bed by arranging the leg bed frame assemblies 7. The raising and lowering functions of the bed body are achieved by arranging the rotating motor 8, and by arranging the gear seat 11, the motor drives the gear seat 11 to rotate during the rotation, achieving the raising and lowering functions of the bed body. By arranging the handles 12, the guardrails can be removed only by pulling the handles 12 in the guardrail slots 3, it is convenient to mount the head bed frame for use by means of the mounting holes and the fixing pins, and the bottom of the medical nursing bed is stabilized for use by means of the cooperation of the back bed frame assemblies 6 and other assemblies.

The above description illustrates the basic principle, main features and advantages of the disclosure. Those of ordinary skill in the art should understand that the disclosure is not limited by the above-described embodiments. The above-described embodiments and the specification only describe the principle of the disclosure. Various changes and improvements of the disclosure can further be made without departing from the spirit and scope of the disclosure, and these changes and improvements shall fall within the claimed scope of protection of the disclosure. The claimed scope of protection of the disclosure is defined by the append claims and their equivalents.

What is claimed is:

1. A practical and economical medical nursing bed, comprising two head bed frame assemblies (1) and guardrail assemblies, wherein the guardrail assemblies are movably mounted on sides of the two head bed frame assemblies (1) respectively and each comprise a guardrail body (2) and a guardrail slot (3), and the medical nursing bed further comprising a bed head hanger piece (4), a connecting rod (5), a back bed frame assembly (6) and a leg bed frame assembly (7), the guardrail body (2) is movably mounted on the side of each head bed frame assembly (1), the guardrail slot (3) is formed in the side of each head bed frame assembly (1), the bed head hanger piece (4) is fixedly mounted on an inner side of one of the two head bed frame assemblies (1), the connecting rod (5) is movably mounted between the two head bed frame assemblies (1), the back bed frame assembly (6) is fixedly mounted on one side of the two head bed frame assemblies (1), the back bed frame assembly (6) is arranged at a bottom of the medical nursing bed, and the leg bed frame assembly (7) is movably mounted between the two head bed frame assemblies (1).

2. The practical and economical medical nursing bed according to claim 1, wherein a rotating motor (8) is fixedly mounted on one side of the back bed frame assembly (6), a foot bed frame assembly (9) is fixedly mounted on opposite sides of the head bed frame assemblies (1), and the foot bed frame assembly (9) is arranged at a foot portion of the medical nursing bed.

3. The practical and economical medical nursing bed according to claim 1, wherein a spring (10) is movably mounted inside the guardrail slot (3).

4. The practical and economical medical nursing bed according to claim 2, wherein a gear seat (11) is fixedly mounted on one side of the rotating motor (8), and the gear seat (11) is arranged on one side of the foot bed frame assembly (9).

5. The practical and economical medical nursing bed according to claim 1, wherein a handle (12) is movably mounted on one side of each head bed frame assembly (1), and the handle (12) is arranged on one side of the guardrail slot (3).

6. The practical and economical medical nursing bed according to claim 1, wherein mounting holes are formed in sides of the head bed frame assemblies (1), and fixing pins are arranged inside the mounting holes.

7. The practical and economical medical nursing bed according to claim 1, wherein the back bed frame assembly comprises a plurality of back bed frame assemblies (6), and each of the back bed frame assemblies (6) has the same specification and function.
